(19) United States
(12) Patent Application Publication
(10) Pub. No.: US 2015/0048179 A1
(43) Pub. Date: Feb. 19, 2015

(54) PROTECTIVE LAWN SPRINKLER APPARATUS

(71) Applicant: Bryan Deane Richardson, Jensen Beach, FL (US)

(72) Inventor: Bryan Deane Richardson, Jensen Beach, FL (US)

(21) Appl. No.: 13/970,457

(22) Filed: Aug. 19, 2013

(51) Int. Cl. B05B 15/00; B29C 39/02; B05B 15/10

(52) U.S. Cl. CPC B05B 15/001; B05B 15/10; B29C 39/02; B29L 2031/70
USPC 239/288.5; 264/334

(57) ABSTRACT

A protective lawn sprinkler apparatus may include an anchor device made from a rock type material, having a top side, a bottom side, an inner rim, an outer edge and an inner edge defining an opening. A pipe sleeve made from a polymer material may be positioned inside the inner edge of the anchor device formed to fit around a sprinkler.

### BACKGROUND OF THE INVENTION

The present invention relates to recessed lawn sprinklers and, more particularly, to a protective lawn sprinkler apparatus.

Currently, sprinkler doughnuts are fragile and do not have enough mass. They do not work well due to the fact that they are susceptible to movement or breakage allowing the sprinkler to drift in orientation. They do not protect and work to preserve the orientation of a lawn sprinkler well. Since they are fragile, they fit common lawn sprinklers in a very loose fashion. They may allow weed and grass infiltration and do not lend themselves to easy location recognition.

As can be seen, there is a need for a protective lawn sprinkler apparatus that may be thicker, have a wider mass, and be tighter to the sprinkler to ensure a more consistent sprinkler orientation, provide separation from surrounding turf and be easy to locate.

### SUMMARY OF THE INVENTION

In one aspect of the present invention, a protective lawn sprinkler apparatus comprises an anchor device made from a rock type material, having a top side, a bottom side, an inner rim, an outer edge and an inner edge defining an opening; and a pipe sleeve made from a polymer material positioned inside the inner edge of the anchor device formed to fit around a sprinkler.

In another aspect of the present invention, a protective lawn sprinkler apparatus comprises an anchor device, having a top side, a bottom side, an inner rim an outer edge and an inner edge defining an opening; and a pipe sleeve positioned inside the inner edge of the anchor device and extended downward beyond the bottom side of the anchor device.

In another aspect of the present invention, a method of constructing a protective lawn sprinkler apparatus comprises laying out a circular form; cutting a pipe sleeve to fit the circular form; pouring a 3000 psi ready mix fiber mesh concrete into the circular form; curing the 3000 psi ready mix fiber mesh concrete creating a ring; and popping the ring out of the circular form.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use;

FIG. 2 is a perspective view of an exemplary embodiment of the present invention;

FIG. 3 is a section view of an exemplary embodiment of the present invention, taken along line 3-3 in FIG. 1; and

FIG. 4 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a protective lawn sprinkler apparatus that may include an anchor device made from a rock type material, having a top side, a bottom side, an inner rim, an outer edge and an inner edge defining an opening. A pipe sleeve made from a polymer material positioned inside the inner edge of the anchor device formed to fit around a sprinkler.

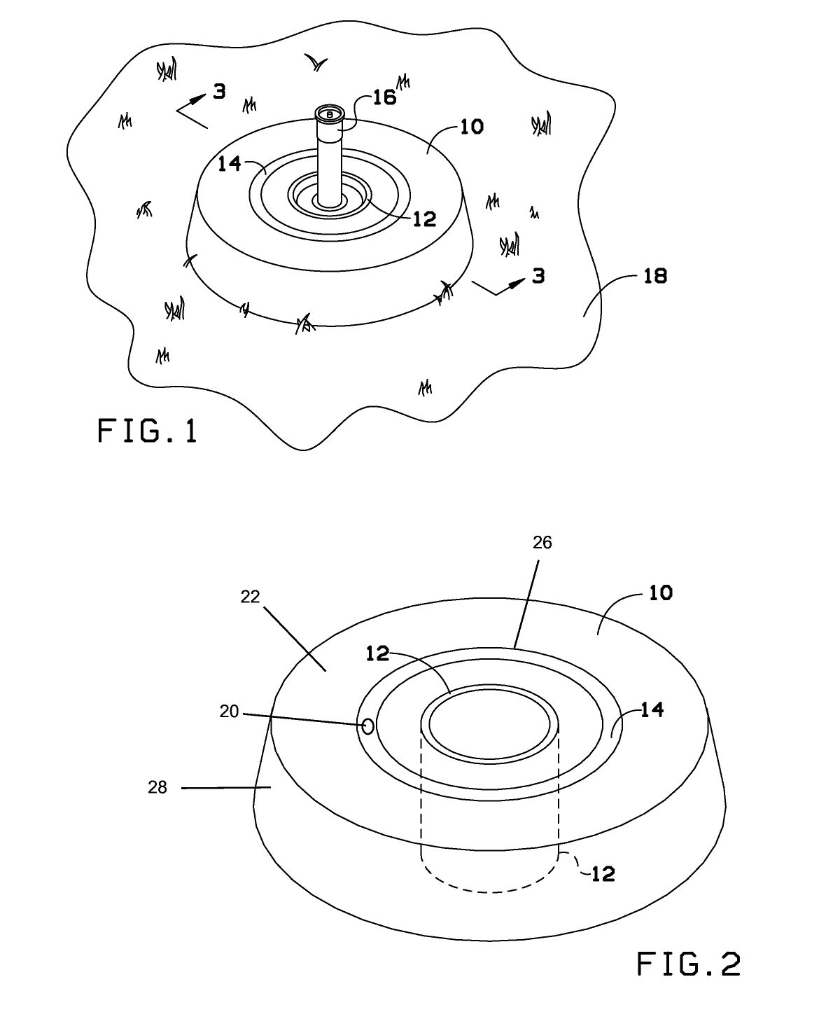

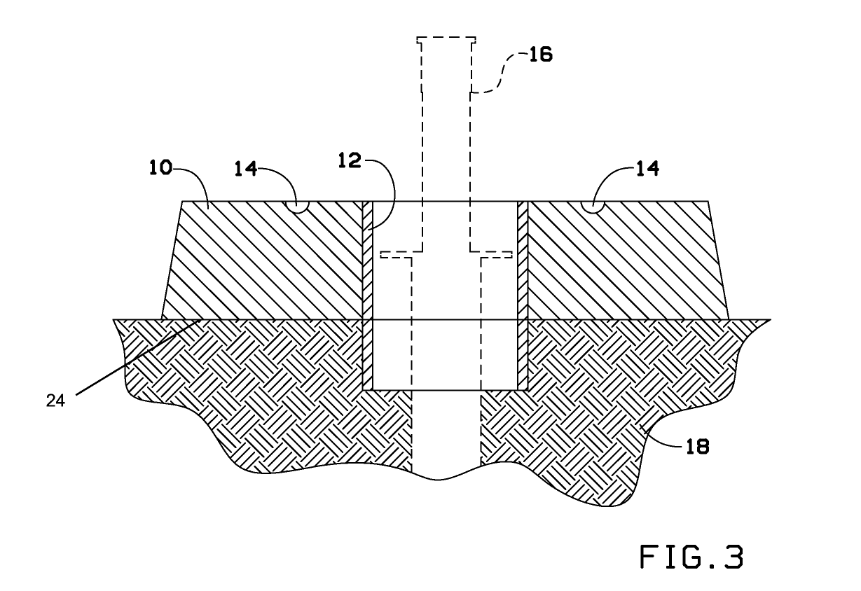

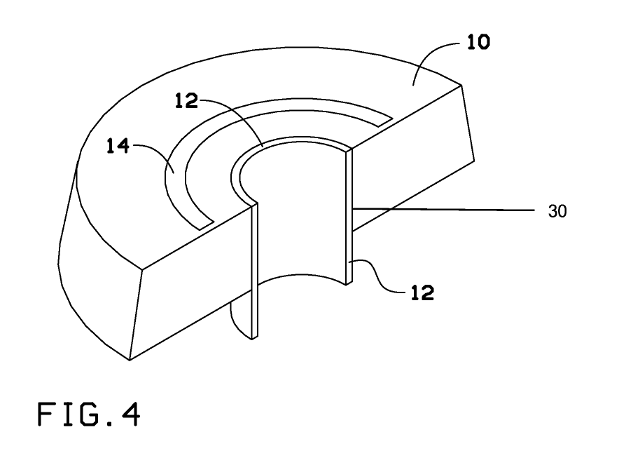

Referring now to FIGS. 1 through 4, the present invention may include an anchor device 10 having a top side 22, a bottom side 24, an inner rim 26, an outer edge 28 and an inner edge 30 defining an opening. The anchor device 10 may be made from concrete or other rock type material. The inner rim of the anchor device 10 may be beveled, which may have a groove 14 located around the inner rim of the anchor device 10. In the center of the anchor device 10 may be a pipe sleeve 12. The pipe sleeve 12 may be formed to fit around a sprinkler 16. The anchor device 10 may rest on the ground 18, and the pipe sleeve 12 may extend downward beyond the bottom side of the anchor device and through the ground 18. In certain embodiments, there may be a hole 20 within the groove 14 of the anchor device 10. The hole may be used to house a screwdriver, or other tool, which may be required for the maintenance of the sprinkler 16.

The anchor device may rest on the ground, and because of the weight and mass of the anchor device, the present device may be secured to the ground. The anchor device may be in the shape of a ring. The anchor device may be placed in a specific position so that when used with a sprinkler, the anchor device may maintain the orientation of the sprinkler. The orientation of the sprinkler may be important for the proper functioning of the sprinkler. The pipe sleeve diameter may be the appropriate size that may provide a tight fit to prevent drift of the sprinkler from its original desired proper placement. The anchor device, if may from concrete, may be made from readymade 3000 psi fiber mix that may protect against common breakage from heavy lawn equipment or automobiles. The pipe sleeve may be made from polyvinyl chloride (PVC) or some similar material. The pipe sleeve may extend from the top side of the anchor device, downward beyond the bottom side of the anchor device and into the ground.

A method of making protective lawn sprinkler apparatus may start with setting up a circular form, cutting the pipe sleeve to fit the circular form, placing the pipe sleeve in the circular form, filling the circular form area around the pipe sleeve with 3000 psi readymix fiber mesh concrete, wait for the concrete to cure creating a ring, then popping the ring out of the circular form.

A method of using the protective lawn sprinkler apparatus may include the following; excavating an area, installing the protective lawn sprinkler apparatus at a specific level so that the lawn sprinkler placement may provide a finished look.

In certain embodiments, the protective lawn sprinkler apparatus has location recognition, which may be important to maintain the apparatus. This advantage may be helpful when an individual may be using a lawn mower around the apparatus location. This way, the individual may avoid the apparatus all together. If the individual does not miss the apparatus, since the apparatus may consist of a rock type material, the apparatus may be able to still operate properly after possibly being run over by a lawn mower. In certain embodiments, the present apparatus may have at least one solar light attached to the outer edge and top side of the anchor device. In certain embodiments, the present device may have different colors along the outer edge and top side of the anchor device in order to be able to distinguish it from the ground. The different colors along the outer edge of the anchor device may also be used to distinguish the type of water that may be used with that particular protective lawn sprinkler apparatus, such as purple for reclaimed water and the like. As is shown in this example, various colors may be used for various types of water.

It should be understood, of course, that the foregoing relates to exemplary embodiments of the invention and that modifications may be made without departing from the spirit and scope of the invention as set forth in the following claims.

What is claimed is:

1. A protective lawn sprinkler apparatus comprising:
an anchor device made from a rock type material, having a top side, a bottom side, an inner rim, an outer edge and an inner edge defining an opening; and
a pipe sleeve made from a polymer material positioned inside the inner edge of the anchor device formed to fit around a sprinkler.

2. The protective lawn sprinkler apparatus of claim 1, wherein the inner edge of the anchor device is circular.

3. The protective lawn sprinkler apparatus of claim 1, wherein the anchor device is ring shaped having an outer diameter.

4. The protective lawn sprinkler apparatus of claim 1, wherein the inner rim of the anchor device is beveled.

5. The protective lawn sprinkler apparatus of claim 1, further comprising a groove along the inner rim of the anchor device.

6. The protective lawn sprinkler apparatus of claim 5, further comprising a hole within the groove of the inner rim of the anchor device.

7. The protective lawn sprinkler apparatus of claim 1, wherein the rock type material is a 3000 psi ready mix fiber mesh concrete.

8. The protective lawn sprinkler apparatus of claim 1, wherein the polymer material is PVC.

9. The protective lawn sprinkler apparatus of claim 3, wherein the anchor device has an outer diameter of around 12 inches.

10. The protective lawn sprinkler apparatus of claim 1, wherein the pipe sleeve has an inside diameter of around 3 inches and is around 4 inches in depth.

11. The protective lawn sprinkler apparatus of claim 1, wherein the anchor device has a depth of around 2.5 inches.

12. The protective lawn sprinkler apparatus of claim 1, further comprising at least one solar light attached to the outer edge and top side of the anchor device.

13. The protective lawn sprinkler apparatus of claim 1, further comprising a color added to the outer edge and top side of the anchor device.

14. A protective lawn sprinkler apparatus comprising:
an anchor device, having a top side, a bottom side, an inner rim, an outer edge and an inner edge defining an opening; and
a pipe sleeve positioned inside the inner edge of the anchor device and extended downward beyond the bottom side of the anchor device.

15. A method of constructing a protective lawn sprinkler apparatus comprising the steps of:
laying out a circular form;
cutting a pipe sleeve to fit the circular form;
pouring a 3000 psi ready mix fiber mesh concrete into the circular form;
curing the 3000 psi ready mix fiber mesh concrete creating a ring; and
popping the ring out of the circular form.
